(19) United States
(12) Patent Application Publication
(10) Pub. No.: US 2010/0115882 A1
(43) Pub. Date: May 13, 2010

(54) MOUNTING FITTING FOR A LIGHTWEIGHT PANEL

(76) Inventors: Petr Seroiszka, Brno (CZ); Lukas Vondra, Kojetin (CZ)

Correspondence Address: MICHAEL J. STRIKER, 103 EAST NECK ROAD, HUNTINGTON, NY, 11743, US

(21) Appl. No.: 12/594,973

(22) PCT Filed: Mar. 22, 2008
(86) PCT No.: PCT/EP2008/002308

§ 371 Date: Oct. 7, 2009

(30) Foreign Application Priority Data
Apr. 12, 2007 (DE) 10 2007 017 556.8

(51) Int. Cl. E04B 1/61; F16B 1/00

(52) U.S. Cl. 52/787.1; 411/82.1

(57) ABSTRACT

The invention relates to a mounting fitting (1) for anchoring in a honeycomb panel (15). The mounting fitting (1) has an adhesive channel (6) and adhesive discharge openings (8). The invention proposes to arrange the adhesive discharge openings (8) in such a way that they are located in a cover panel (16) of the honeycomb panel (15) and to construct the mounting fitting (1) with an adhesive distribution groove (9) running like a screw-thread around the periphery, into which the adhesive discharge openings (8) open. It is thus ensured that there is good distribution of adhesive and that the hole (18) in the cover panel (16) of the honeycomb panel (15) is completely filled with adhesive. Adhesive discharged on the inner side of the cover panel (16) improves adhesion.

The invention relates to a mounting fitting for a lightweight panel having the features of the preamble of claim 1. The invention relates also to an arrangement having such a mounting fitting and to a method of bonding the mounting fitting in place, having the features of the preambles of claims 13 and 14.

A “lightweight panel” is to be understood as being a panel having two cover panels which are joined by a core of low mechanical strength. The core can be, for example, a foam or can be a honeycomb; the latter case is referred to as a honeycomb panel. Honeycomb panels are used, for example, in the manufacture of furniture and need to be joined to one another or to other components. The mechanical strength of the core is not sufficient for a stable anchoring. Any reference to a honeycomb panel hereinbelow is to be understood as also including a lightweight panel generally.

WO 2006/106131 A1 discloses a mounting fitting for a lightweight panel referred to as a “connection insert”. The known mounting fitting has a kind of hollow bolt having a head and a sleeve arranged on the hollow bolt. The internal diameter of the sleeve is larger than the external diameter of the hollow bolt so that an annular gap is formed. The mounting fitting is inserted into a lightweight panel through a hole in a cover panel of the lightweight panel until the head is located inside the cover panel and ends flush therewith. Adhesive is then introduced into the hollow bolt, the adhesive being discharged from the hollow bolt through radial openings and entering the annular gap between the sleeve and the hollow bolt. The adhesive becomes distributed in the annular gap and is discharged at both ends of the sleeve, so that it joins the mounting fitting on inner sides to the cover panels of the lightweight panel. The hollow bolt of the known mounting fitting also has discharge openings in its head through which adhesive is discharged into the hole in the one cover panel of the lightweight panel and bonds the head to the cover panel. The mounting fitting which has been inserted into the lightweight panel and bonded to its cover panels forms a fixing point for the connection of the lightweight panel to another component.

The problem of the present invention is to propose a mounting fitting for a lightweight panel having improved distribution of adhesive.

That problem is solved according to the invention by the features of claim 1. The mounting fitting according to the invention having the features of claim 1 has an adhesive channel in its interior having an adhesive filling opening at one end face of the mounting fitting and having at least one adhesive discharge opening close to the one end face at one side, that is to say on the periphery, of the mounting fitting. Close to the end face of the mounting fitting at which the adhesive filling opening is located means that the adhesive discharge opening is arranged on the mounting fitting at a location that is preferably inside one of the two cover panels of a lightweight panel when the mounting fitting has been inserted into the lightweight panel in the intended way. Adhesive introduced into the adhesive channel of the mounting fitting is discharged in a hole in the cover panel of the lightweight panel into which the mounting fitting has been inserted.

Furthermore, the mounting fitting according to the invention has on its outer side an adhesive distribution groove into which the adhesive discharge opening opens. The adhesive distribution groove runs in such a way that adhesive entering it from the adhesive discharge opening is distributed in the peripheral direction and in the longitudinal direction. For example, the adhesive distribution groove can have grooves running in the longitudinal and peripheral directions and crossing one another like a lattice. One construction in accordance with the invention provides an adhesive distribution groove running like a screw-thread around the periphery. The adhesive distribution groove is arranged in a region of the mounting fitting that is located in the cover panel of a lightweight panel when the mounting fitting has been inserted into the lightweight panel in the intended way. The adhesive distribution groove can extend further over the length of the mounting fitting, that is to say into a region of the mounting fitting that is located between the cover panels of a lightweight panel when the mounting fitting has been inserted into the lightweight panel in the intended way. Adhesive discharged from the adhesive discharge opening(s) flows in the adhesive distribution groove, which is surrounded and covered by the wall of the hole in the cover panel of the lightweight panel into which the mounting fitting has been inserted, and thus becomes distributed in the hole in the cover panel. In addition, the adhesive is discharged from the adhesive distribution groove on the inner side of the cover panel. By means of the adhesive distribution groove according to the invention, it is possible for the annular gap surrounding the mounting fitting in the hole in the cover panel to be filled completely with adhesive, so that a good full-surface bond capable of bearing high mechanical stress is achieved. The adhesive that is also discharged on the inner side of the cover panel bonds the mounting fitting to the cover panel at that location and where applicable to the core or the honeycomb of the lightweight panel, so that the strength of the bond between the mounting fitting and the lightweight panel is further increased. “Like a screw-thread” is to be understood as meaning that the adhesive distribution groove runs in the peripheral direction and in the longitudinal direction of the mounting fitting in order to distribute the adhesive both in the peripheral direction and in the axial direction in the hole in the cover panel. “Like a screw-thread” does not necessarily mean that the adhesive distribution groove has a constant pitch.

An advantage of the invention is the good distribution of the adhesive in the hole in the cover panel of the lightweight panel into which the mounting fitting has been inserted, and on the inner side of the cover panel.

In a preferred construction in accordance with the invention, the adhesive distribution groove is closed at the one end face of the mounting fitting having the adhesive filling opening. “Closed” means that the adhesive distribution groove does not end in an opening at the one end face of the mounting fitting. The adhesive distribution groove can end a short distance before the one end face of the mounting fitting; the mounting fitting can also have a radially outwardly projecting flange by means of which the adhesive distribution groove is closed. By means of the flange, the mounting fitting is seated on the outer side of the cover panel of the lightweight panel into which the mounting fitting has been inserted. The closed end of the adhesive distribution groove prevents or at least reduces discharge of adhesive at the one end face of the mounting fitting having the adhesive filling opening. The adhesive therefore flows in the other direction and is discharged, as desired, on the inner side of the cover panel of the lightweight panel. Discharge of adhesive on the outer side of the cover panel is avoided or at least reduced.

In a further preferred construction in accordance with the invention, the adhesive distribution groove has a large free cross-sectional area in relation to the total cross-sectional area, the total cross-sectional area being understood as the cross-section up to the groove depth of the adhesive distribution groove. The large free cross-sectional area of the adhesive distribution groove reduces the flow resistance of the adhesive and enlarges the contact area with the wall of the hole in the cover panel, that is to say the area of the adhesive distribution groove that is open on the outer side of the mounting fitting.

For bonding the mounting fitting to the other cover panel of the lightweight panel, one construction in accordance with the invention provides one or more discharge openings at the other end face of the mounting fitting. The “other end face” is to be understood as being the end face of the mounting fitting remote from the end face having the adhesive filling opening. For discharge of adhesive, the other end face can be open or can have openings and/or the adhesive discharge openings are provided at the side, that is to say in the periphery of the mounting fitting, at or close to the other end face. By virtue of that construction in accordance with the invention, the mounting fitting is bonded to both cover panels of the lightweight panel and its mechanical hold in the lightweight panel is further improved. There is no need to prepare the other cover panel of the lightweight panel; to insert the mounting fitting it is necessary merely to make a hole in one cover panel of the lightweight panel.

One construction in accordance with the invention provides a displaceable extension piece for the mounting fitting. The extension piece can be, for example, in the form of a sleeve and arranged on the mounting fitting or, conversely, the mounting fitting can be in the form of a sleeve and the extension piece can be arranged therein. The extension piece has an adhesive channel which communicates with the adhesive channel of the mounting fitting. That is to say, adhesive introduced into the mounting fitting through the adhesive filling opening not only is discharged into the adhesive distribution groove from the adhesive discharge opening(s) of the mounting fitting, but also overflows from the mounting fitting into the displaceable extension piece. From the extension piece, the adhesive is discharged through one or more adhesive discharge openings arranged at an end face remote from the adhesive filling opening of the mounting fitting and/or at one side of the extension piece close to the end face of the extension piece remote from the adhesive filling opening of the mounting fitting. The mounting fitting is inserted into a hole in a cover panel in a lightweight panel with the extension piece extended, that is to say with the extension piece increasing the length of the mounting fitting. The extension piece strikes the inner side of the other cover panel. The mounting fitting is introduced further into the lightweight panel until it ends flush with the one cover panel or is seated by its flange on the cover panel, the mounting fitting being displaced along the extension piece so that the mounting fitting is automatically adapted to the thickness of the lightweight panel. The adhesive then introduced is discharged, as described above, in the region of the one cover panel. In addition, the adhesive is discharged from the adhesive discharge opening(s) of the extension piece at the inner side of the other cover panel and bonds the mounting fitting to that cover panel also. The mounting fitting is thus bonded to both cover panels of the lightweight panel.

One construction in accordance with the invention provides a throug hflow throttle in the adhesive channel of the mounting fitting or its extension piece. The throughflow throttle is especially a change in cross-section, for example an aperture plate in the adhesive channel. The throughflow throttle brings about damming of the introduced adhesive in order that a sufficient amount of adhesive is discharged from the adhesive discharge opening(s) of the mounting fitting into the adhesive distribution groove.

In a preferred construction in accordance with the invention, the mounting fitting is cylindrical, i.e. has a cylindrical outer surface, and is thus matched to a cylindrical drilled hole in the cover panel of the lightweight panel. A cylindrical shape or a cylindrical envelope in the region of the one cover panel of the lightweight panel may be sufficient.

In a preferred construction in accordance with the invention, the adhesive channel is constructed to serve simultaneously as a screw channel for the introduction of a screw. That means, in particular, a straight construction of the adhesive channel having an adequate cross-section. The cross-section of the adhesive channel can be larger than the thread diameter of the screw, so that the screw is not directly in engagement with the mounting fitting, but indirectly by way of the adhesive introduced into the mounting fitting. Instead of a screw it is also possible for a different, pin-like element to be introduced into the mounting fitting as anchor. The screw can be understood generally as being an element having an external thread.

In one construction in accordance with the invention, the mounting fitting can be reduced in length to match different thicknesses of lightweight panel. That is possible, for example, by means of the displaceable extension piece of the mounting fitting which has already been described. Another possibility is a crushable or crumplable construction of the mounting fitting. The mounting fitting can be resiliently and/or plastically deformable; it can have a bellows-like or concertina-like construction at least over a part of its length. A lattice-like, preferably diagonal or lozenge-shaped construction, of a wall portion of the mounting fitting is also possible for the purpose of its being reducible in length. That has the additional advantage that the holes of the lattice-like peripheral wall can form adhesive discharge openings. One construction in accordance with the invention provides one or more folding elements which, to reduce the length of the mounting fitting, fold outwards or inwards when the mounting fitting strikes the inner side of the other cover panel of the lightweight panel with the folding elements. With the mentioned possible length-reducing methods, the mounting fitting can also be of one-piece construction.

In the method according to the invention, a mounting fitting according to the invention, especially of the kind described above, is inserted into a lightweight panel through a hole in a cover panel of the lightweight panel and adhesive is introduced through the adhesive filling opening at one end face of the mounting fitting. The adhesive is discharged through the adhesive discharge openings and bonds the mounting fitting to at least one, preferably both, of the two cover panels of the lightweight panel. After the adhesive has hardened, a screw or generally an element having an external thread is screwed, without pre-drilling, into the adhesive channel of the mounting fitting. The screw or the element having an external thread enables another component to be joined to the lightweight panel. A screw or an element having an external thread can be screwed into the adhesive channel of the mounting fitting, that is to say it is in engagement with the mounting fitting. A fixing made exclusively by means of the adhesive in the adhesive channel, without direct thread engagement between the screw or generally the element having an external thread and the mounting fitting, is also possible, in which case the mounting fitting serves chiefly for distribution of the adhesive while the effective loads that arise are transmitted to the honeycomb panel predominantly by the screw by way of the adhesive.

The invention relates also to an arrangement of a mounting fitting of the kind described above which has been inserted into a lightweight panel and bonded to one or preferably both of the cover panels thereof in the way described.

The invention is described in greater detail below on the basis of exemplary embodiments shown in the drawing:

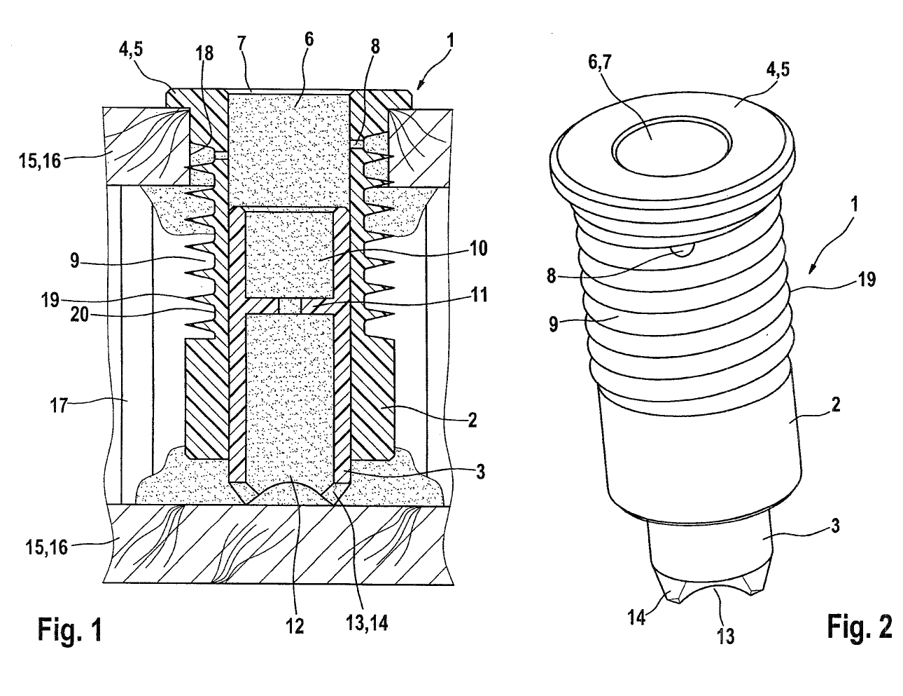

FIG. 1 is an axial section through a mounting fitting according to the invention;

FIG. 2 is a perspective view of the mounting fitting shown in FIG. 1; and

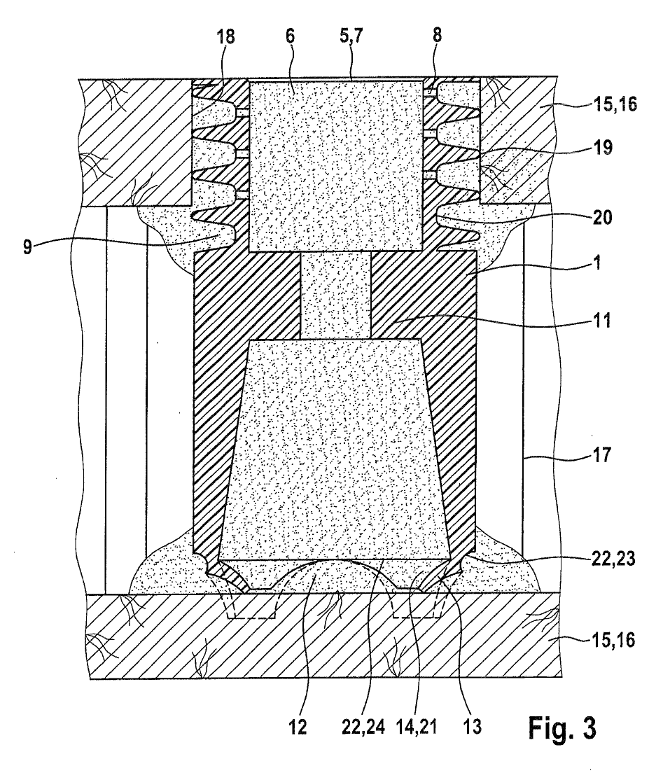

FIG. 3 is an axial section through a second embodiment of the invention.

The mounting fitting 1 according to the invention shown in FIGS. 1 and 2 has a first part 2 and an extension piece 3. The first part 2 and/or the extension piece 3 can be made, for example, by injection-moulding from plastics material. Hereinbelow, the term mounting fitting 1 refers to the first part 2 or alternatively to the first part 2 and the extension piece 3.

The first part 2 of the mounting fitting 1 according to the invention takes the form of a cylindrical sleeve having an outwardly projecting radial flange 4 at one end face 5. The interior of the tubular first part 2 forms an adhesive channel 6 the mouth of which at the one end face 5 of the first part 2 forms an adhesive filling opening 7 of the mounting fitting 1. Just underneath the radial flange 4, that is to say close to the one end face 5, the first part 2 has adhesive discharge openings 8 which pass through its wall. In the exemplary embodiment of the invention shown and described, the first part 2 has two adhesive discharge openings 8 which are arranged opposite one another. The number and arrangement of the adhesive discharge openings 8 is not essential to the invention, however. On its outer side, the first part 2 has an adhesive distribution groove 9 running like a screw-thread around the periphery, which extends from the radial flange 4 over about ⅔ of the length of the first part 2. At the one end face 5 of the first part 2 having the adhesive filling opening 7, the adhesive distribution groove 9 is closed by the radial flange 4. The adhesive discharge openings 8 open into the adhesive distribution groove 9.

The extension piece 3 is likewise a sleeve-like part which is displaceable in the sleeve-like first part 2 of the mounting fitting 1. The interior of the tubular extension piece 3 forms an adhesive channel 10 which communicates with the adhesive channel 6 of the first part 2; the adhesive channels 6, 10 of the first part 2 and the extension piece 3 merge into one another. The extension piece 3 has an aperture plate as throughflow throttle 11 in its adhesive channel 10. The mouth of the adhesive channel 10 at the end face of the extension piece 3 remote from the radial flange 4 forms an adhesive discharge opening 12. The end face of the extension piece 3 has arcs which can also be understood as adhesive discharge openings 13. Between the concave arcs, the end edge of the extension piece 3 forms feet 14.

As shown in FIG. 1, the mounting fitting 1 according to the invention is provided for anchoring in a lightweight panel, for example, as shown, in a honeycomb panel 15. The honeycomb panel 15 has two cover panels 16 between which there is honeycomb 17 which joins the two cover panels 16.

For insertion of the mounting fitting 1, a hole 18 is drilled in the one cover panel 16 and where applicable the honeycomb 17 below the hole 18 is destroyed. Prior to insertion into the honeycomb panel 15, the mounting fitting 1 has been fully extended, that is to say the extension piece 3 has been moved out of the first part 2 by the maximum amount. The mounting fitting 1 is inserted, extension piece 3 first, through the hole 18 into the honeycomb panel 15, the extension piece 3 striking the other cover panel 16 of the honeycomb panel 15. The first part 2 of the mounting fitting 1 is introduced into the honeycomb panel 15 to a depth such that the radial flange 4 is seated on the outer side of the one cover panel 16, the extension piece 3, which is in contact with the inner side of the other cover panel 16, moving into the first part 2. The mounting fitting 1 thus adapts itself automatically to the thickness of the honeycomb panel 15. If a raised portion, caused by the radial flange 4, on the one cover panel 16 of the honeycomb panel 15 is undesirable, the mounting fitting 1 can also be configured without the radial flange 4 (not shown) and can be introduced into the honeycomb panel 15 to end flush with the outer side of the one cover panel 16.

After insertion into the honeycomb panel 15, the adhesive distribution groove 9 is located in the hole 18 in the one cover panel 16 of the honeycomb panel 15. The adhesive distribution groove 9 extends further into the intermediate space between the two cover panels 16.

Using a device not shown, adhesive is introduced under pressure through the adhesive filling opening 7 into the mounting fitting 1 which has been inserted into the honeycomb panel 15. The adhesive becomes distributed in the adhesive channel 6 and is discharged through the adhesive discharge openings 8 into the adhesive distribution groove 9. The adhesive flows through the adhesive distribution groove 9 and thus becomes distributed over the periphery and in the axial or longitudinal direction in the hole 18 in the one cover panel 16. The hole 18 in the cover panel 16 surrounding the mounting fitting 1 is filled completely by the adhesive. In addition, adhesive is discharged on the inner side of the cover panel 16 and at that location too bonds the mounting fitting 1 to the cover panel 16. The adhesive is discharged from the adhesive channel 6 of the first part into the adhesive channel 10 of the extension piece 3, flows through the throughflow throttle 11 and is discharged from the adhesive discharge openings 12, 13 of the extension piece 3. At the end face of the extension piece 3 it becomes distributed on the inner side of the other cover panel 16 of the honeycomb panel 15 and thus bonds the mounting fitting 1 also to the other cover panel 16, so that the mounting fitting 1 is firmly bonded to both cover panels 16 of the honeycomb panel 15. The aperture plate forming the throughflow throttle 11 brings about damming of the adhesive and ensures that a sufficient amount of adhesive flows under sufficient pressure through the adhesive discharge openings 8 of the first part 2 of the mounting fitting 1 into the adhesive distribution groove 9 and further in the adhesive distribution groove 9, so that the adhesive becomes distributed in the hole 18 in the cover panel 16. It is thus ensured that the hole 18 is completely filled with adhesive and that adhesive is discharged on the inner side of the one cover panel 16.

In accordance with an embodiment of the invention, a screw (not shown in the drawing) or some other element having an external thread is screwed, without pre-drilling, through the adhesive filling opening 7 into the adhesive channel 6, 10 of the mounting fitting 1 when the adhesive has hardened. Since the extension piece 3 of the mounting fitting 1 consists of plastics material, the screw can pass through the aperture plate forming the throughflow throttle 11. The adhesive channel 6, 10 thus simultaneously forms a screw channel. The screw enables a component (not shown) to be joined to the honeycomb panel 15. The thread of the screw can be, but not need not be, in engagement with the mounting fitting 1.

The adhesive distribution groove 9 has steep groove flanks which end in a blade-like but blunt edge 19. The groove base 20 is rounded, so that the adhesive distribution groove 9 is wide also in the region of the groove base 20. The adhesive distribution groove 9 thus has a large free cross-sectional area and consequently a low flow resistance for the adhesive. The open area of the adhesive distribution groove 9 facing the wall of the hole 18 in the cover panel 16 of the honeycomb panel 15 is also large.

In the subsequent description of the mounting fitting 1 shown in FIG. 3, essentially only the differences with respect to the mounting fitting 1 shown in FIGS. 1 and 2 are described and, in addition, to explain FIG. 3 reference is made to the descriptions of FIGS. 1 and 2. In FIG. 3, corresponding components have been given the same reference numerals as in FIG. 1.

Unlike the mounting fitting 1 shown in FIGS. 1 and 2, the mounting fitting 1 shown in FIG. 3 is in one piece; it does not have a displaceable extension piece. For adapting to different thicknesses of honeycomb panel 15, the mounting fitting 1 shown in FIG. 3 can be reduced in length. Its feet 14 are in the form of folding elements 21 which, in the un-deformed starting position, are directly obliquely inwards. The un-deformed starting position is shown by dotted lines in FIG. 3. The folding elements 21 are integral with a wall of the mounting fitting 1 via a folding site or folding line 22. The folding line 22 is formed by a peripheral groove 23 on the outer side of the mounting fitting 1 and a concave peripheral edge 24 on the inner side of the mounting fitting 1. If the mounting fitting 1 is introduced into the honeycomb panel 15 and its feet 14, formed as folding elements 21, strike the inner side of the other cover panel 16, as a result of their obliquely inwardly oriented alignment the feet fold inwards along the folding line 22 into the position shown by solid lines in FIG. 3. In principle, it is also possible for the feet 14 to fold outwards in order to reduce the length of the mounting fitting 1 for adapting to different thicknesses of honeycomb panel 15.

As in FIGS. 1 and 2, the mounting fitting 1 shown in FIG. 3 is a sleeve-like part having an adhesive channel 6, an adhesive filling opening 7 at one end face 5 of the mounting fitting 1 and an aperture plate as throughflow throttle 11 approximately in the longitudinal centre of the adhesive channel 6.

Likewise in accordance with FIGS. 1 and 2, the mounting fitting 1 shown in FIG. 3 has, close to its one end having the adhesive filling opening 7, adhesive discharge openings 8 which open into a helical adhesive distribution groove 9. When the mounting fitting 1 has been inserted into the honeycomb panel 5, the adhesive discharge openings 8 are located in a hole 18 in the one cover panel 16 of the honeycomb panel 15. The mounting fitting 1 shown in FIG. 3 has more adhesive discharge openings 8 that open into the adhesive distribution groove 9 than does the mounting fitting 1 shown in FIGS. 1 and 2.

The mounting fitting 1 shown in FIG. 3 does not have a flange at its end face; it is inserted into the honeycomb panel 15 to end flush with the outer side of the one cover panel 16 of the honeycomb panel 15. The adhesive distribution groove 9 is closed at one end face 5 of the mounting fitting 1, so that no adhesive, or at least very little adhesive, is discharged at that location. The adhesive thus becomes distributed in the hole 18 in the one cover panel 16 of the honeycomb panel 15 and flows onto the inner side of the cover panel 16.

The mounting fitting 1 shown in FIG. 3 otherwise corresponds to the mounting fitting 1 shown in FIGS. 1 and 2 and to avoid repetition reference is made to the descriptions of FIGS. 1 and 2.

### LIST OF REFERENCE NUMERALS

1 mounting fitting
2 first part
3 extension piece
4 radial flange
5 an end face
6 adhesive channel
7 adhesive filling opening
8 adhesive discharge opening
9 adhesive distribution groove
10 adhesive channel
11 throughflow throttle
12 adhesive discharge opening
13 adhesive discharge opening
14 foot
15 honeycomb panel
16 cover panel
17 honeycomb
18 hole
19 edge
20 groove base
21 folding element
22 folding line
23 groove
24 edge

1. Mounting fitting for a lightweight panel, having in its interior an adhesive channel (6), which has an adhesive filling opening (7) at one end face (5) and at least one adhesive discharge opening (8) at one side of the mounting fitting (1) close to the one end face (5), characterized in that the mounting fitting (1) has on its outer side in the region of its one end face (5) an adhesive distribution groove (9) into which the adhesive discharge opening (8) opens and which distributes adhesive entering it from the adhesive discharge opening (8) in the peripheral direction and in the longitudinal direction of the mounting fitting (1).

2. Mounting fitting according to claim 1, characterized in that the adhesive distribution groove (9) runs like a screw-thread around the periphery.

3. Mounting fitting according to claim 1, characterized in that the adhesive distribution groove (9) is closed at the one end face (5) of the mounting fitting (1).

4. Mounting fitting according to claim 1, characterized in that the adhesive distribution groove (9) has a large free cross-sectional area in comparison with the total cross-sectional area.

5. Mounting fitting according to claim 1, characterized in that the adhesive channel (6) has an adhesive discharge opening (12, 13) at the end face of the mounting fitting (1) remote from the adhesive filling opening (7).

6. Mounting fitting according to claim 1, characterized in that the mounting fitting (1) has a displaceable extension piece (3) having an adhesive channel (10) which communicates with the adhesive channel (6) of the mounting fitting (1), and the adhesive channel (10) of the extension piece (3) has an adhesive discharge opening (12, 13) at the end face remote from the adhesive filling opening (7) of the mounting fitting (1) and/or at one side of the extension piece (3) close to the end face remote from the adhesive filling opening (7) of the mounting fitting (1).

7. Mounting fitting according to claim 1, characterized in that the adhesive channel (6, 10) has a throughflow throttle (11) for the adhesive.

8. Mounting fitting according to claim 1, characterized in that the mounting fitting (1) is cylindrical.

9. Mounting fitting according to claim 1, characterized in that the adhesive channel (6, 10) is simultaneously a screw channel for the introduction of a screw.

10. Mounting fitting according to claim 1, characterized in that the mounting fitting (1) can be reduced in length.

11. Mounting fitting according to claim 10, characterized in that the mounting fitting (1) has one or more folding element(s) (21) which is/are foldable inwards and/or outwards to reduce the length of the mounting fitting (1).

12. Mounting fitting according to claim 1, characterized in that the mounting fitting (1) is in one piece.

13. Arrangement having a mounting fitting (1) which has been inserted into a honeycomb panel (15), the mounting fitting (1) having an adhesive channel (6) in its interior, an adhesive filling opening (7) at one end face (5) and at least one adhesive discharge opening (8) at one side of the mounting fitting (1) close to the one face end (5), and the mounting fitting (1) having been inserted into the honeycomb panel (15) through a hole (18) in a cover panel (16) of the honeycomb panel (15) and having been bonded to the cover panel (16), characterized in that the mounting fitting (1) has on its outer side an adhesive distribution groove (9), into which the adhesive discharge opening (8) opens and which runs in such a way that adhesive entering it from the adhesive discharge opening (8) is distributed in the peripheral direction and in the longitudinal direction of the mounting fitting (1), and the adhesive discharge opening (8) is located in the cover panel (16) of the honeycomb panel (15), and the adhesive distribution groove (9) is located in the cover panel (16) of the honeycomb panel (15) and extends as far as between the two cover panels (16) of the honeycomb panel (15), and adhesive introduced into the mounting fitting (1) through the adhesive filling opening (7) and discharged through the adhesive discharge opening (8) joins the mounting fitting (1) to the cover panel (16) of the honeycomb panel (15).

14. Method of bonding a mounting fitting (1) into a honeycomb panel (15), the mounting fitting (1) having an adhesive channel (6) with an adhesive filling opening (7) at one end face (5) of the mounting fitting (1) and at least one adhesive discharge opening (8, 12, 13), wherein the mounting fitting (1) is inserted into the honeycomb panel (15) through a hole (18) in a cover panel (16) of the honeycomb panel (15), adhesive is introduced into the mounting fitting (1) through the adhesive filling opening (7) and is discharged through the adhesive discharge opening (8, 12, 13) and bonds the mounting fitting (1) to the honeycomb panel (15), and an element having an external thread is screwed, without pre-drilling, into the hardened adhesive in the adhesive channel (6) of the mounting fitting (1).

15. Method according to claim 14, characterized in that the mounting fitting (1) has an adhesive distribution groove (9) into which an adhesive discharge opening (8) close to the one end face (5) opens and by means of which the adhesive discharged into it from the adhesive discharge opening (8) is distributed in the hole (18) in the cover panel (16) of the honeycomb panel (15) around the mounting fitting (1) and in the longitudinal direction thereof and is led into the honeycomb panel (15) as far as the inner side of the cover panel (16).
